(19) United States
(12) Patent Application Publication
(10) Pub. No.: US 2024/0057139 A1
(43) Pub. Date: Feb. 15, 2024

(54) OPTIMIZATION OF DETERMINISTIC AND NON-DETERMINISTIC TRAFFIC IN RADIO-ACCESS NETWORK (RAN)

(71) Applicant: NOKIA SOLUTIONS AND NETWORKS OY, Espoo (FI)

(72) Inventors: Devaki Chandramouli, Plano, TX (US); Swaminathan Arunachalam, Allen, TX (US); Navin Hathiramani, Coppell, TX (US)

(21) Appl. No.: 18/264,693

(22) PCT Filed: Jan. 31, 2022
(86) PCT No.: PCT/EP2022/052194

§ 371 Date: Aug. 8, 2023

Related U.S. Application Data
(60) Provisional application No. 63/200,000, filed on Feb. 8, 2021.

(51) Int. Cl. H04W 72/51; H04W 24/08; H04W 24/10

(52) U.S. Cl. CPC H04W 72/51; H04W 24/08; H04W 24/10

(57) ABSTRACT

Various techniques are provided for generating, by a base station (BS), a user equipment (UE) report for a UE associated with the BS, associating, by the BS, an application identification or correlation (ID) along with the UE report, the ID being associated with an application category being served by at least one data radio bearer (DRB) or it is an identifier referring to a specific application detection filter identifying an application that is served by the DRB, receiving, by the BS, assistance information based on the reports sent for the DRB, the assistance information being associated with the application, and scheduling, by the BS, resources for the UE based on the assistance information.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments. Aspects of LTE are also continuing to improve.

5G New Radio (NR) development is part of a continued mobile broadband evolution process to meet the requirements of 5G, similar to earlier evolution of 3G and 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include generating, by a base station (BS), a user equipment (UE) report for a UE associated with the BS, associating, by the BS, an application identification or correlation (ID) along with the UE report, the ID being associated with an application category being served by at least one data radio bearer (DRB) or it is an identifier referring to a specific application detection filter identifying an application that is served by the DRB, receiving, by the BS, assistance information based on the reports sent for the DRB, the assistance information being associated with the application, and scheduling, by the BS, resources for the UE based on the assistance information.

Implementations can include one or more of the following features, alone, or in any combination with each other. For example, the method can further include monitoring, by the BS, a traffic pattern for an uplink (UL) on the DRB associated with the UE, monitoring, by the BS, a traffic pattern for a downlink (DL) on the DRB associated with the UE, wherein the UE report is based on data associated with the application acquired during the monitoring of the UL and the monitoring of the DL. The assistance information can include Time Sensitive Communication Assistance Information (TSCAI). The ID can be a Correlation ID received by the BS from a session management function (SMF). The ID can be a correlation ID associated with an application category being served over one or more DRBs. The Correlation ID can be derived by the SMF based on the Traffic Flow Templates employed to map the service flows to the radio bearers. The UE report can be based on data associated with the application and a plurality of UEs employing the application. The UE report can be based on data associated with the UE implementing a plurality of applications and each of the plurality of applications is associated with a unique ID. The assistance information can be based on a statistical or machine learning (ML) model processing a plurality of UE reports.

According to an example embodiment, a method may include receiving, by a RAN intelligent controller (RIC) from a base station (BS), a user equipment (UE) report, the UE report including an identification (ID) associating the UE with an application, generating, by the RIC, application traffic patterns based on the UE report using a machine learning (ML) or a statistical model, generating, by the RIC, assistance information based on the traffic patterns using the ML or statistical model, and communicating, by the RIC, the assistance information to the BS.

Implementations can include one or more of the following features, alone, or in any combination with each other. For example, the UE report can be based on data associated with the application acquired during a monitoring of an uplink (UL) on a data radio bearer (DRB) associated with the UE and the monitoring of a downlink (DL) on the DRB associated with the UE. The ID can be a Correlation ID received by the BS from a session management function (SMF). The ID can be a correlation ID associated with an application category being served over one or more DRB. The Correlation ID can be derived by the SMF based on the Traffic Flow Templates employed to map the service flows to the radio bearers. The application traffic can be based on one application employed by a plurality of UEs. The RIC can include a near-real time RIC and a non-real time RIC and the ML model is trained by the non-real time RIC. The assistance information can include Time Sensitive Communication Assistance Information (TSCAI). The RIC can collect information from a plurality of UE reports associated with the application over a period of time, and the assistance information can be based on the information collected over a period of time.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a block diagram illustrating a portion of a radio-access network (RAN) architecture according to an example embodiment.

FIG. 3 is a RAN signal flow diagram according to an example embodiment.

FIG. 4 is a block diagram of a method for optimizing traffic according to an example embodiment.

FIG. 5 is a block diagram of a method for generating per application traffic patterns according to an example embodiment.

FIG. 6 is a flowchart illustrating operation of a network device according to an example embodiment.

FIG. 7 is a flowchart illustrating operation of a network device according to an example embodiment.

FIG. 8 is a block diagram of a wireless station or wireless node (e.g., AP, BS, gNB, RAN node, relay node, UE or user device, network node, network entity, DU, CU-CP, CU-CP, . . . or other node) according to an example embodiment.

### DETAILED DESCRIPTION

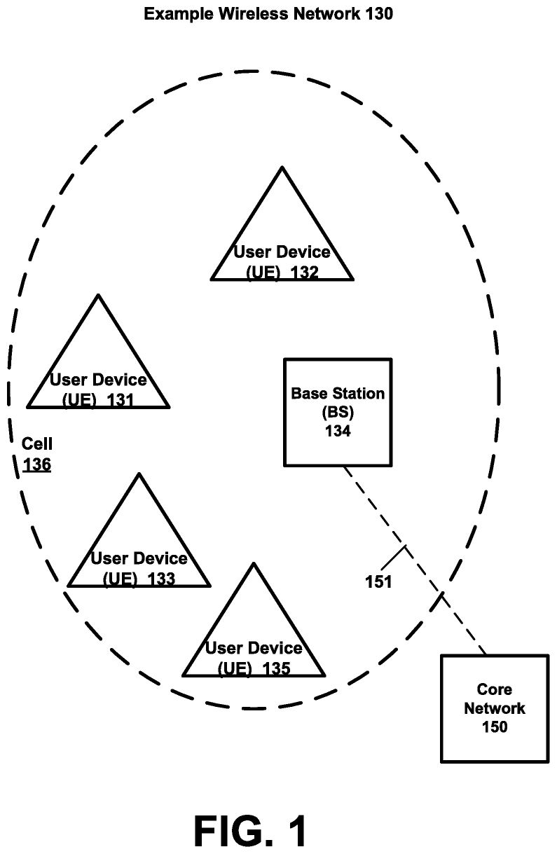

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e)Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DUs may provide one or more cells, and may allow UEs to communicate with and/or establish a connection to the DU in order to receive wireless services, such as allowing the UE to send or receive data. A centralized (or central) unit (CU) may provide control functions and/or data-plane functions for one or more connected DUs, e.g., including control functions such as gNB control of transfer of user data, mobility control, radio access network sharing, positioning, session management, etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network (e.g., which may be referred to as 5GC in 5G/NR).

In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), massive MTC (mMTC), Internet of Things (IoT), and/or narrowband IoT user devices, enhanced mobile broadband (eMBB), and ultra-reliable and low-latency communications (URLLC). Many of these new 5G (NR)—related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

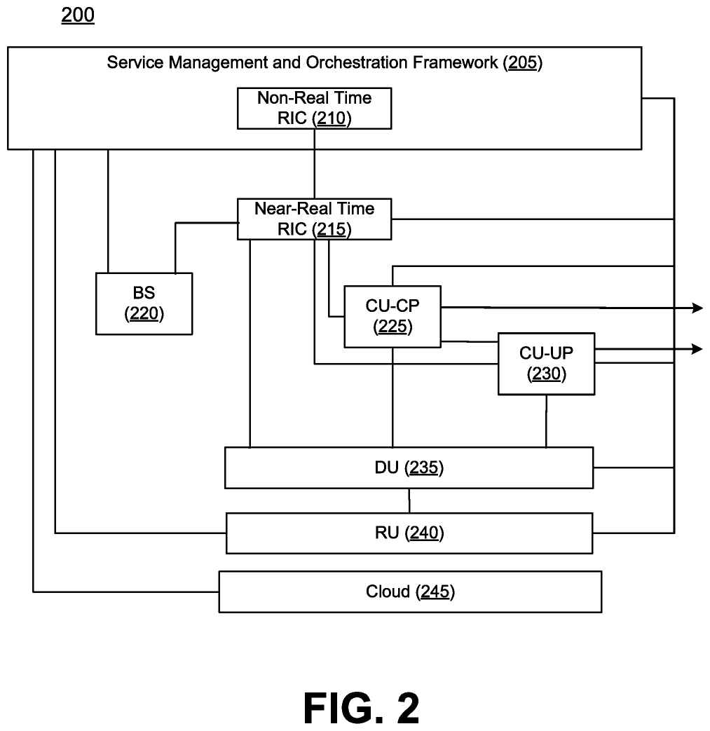

The various example embodiments may be applied to a wide variety of wireless technologies or wireless networks, such as LTE, LTE-A, 5G (New Radio (NR)), cmWave, and/or mmWave band networks, IoT, MTC, eMTC, mMTC, eMBB, URLLC, etc., or any other wireless network or wireless technology. These example networks, technologies or data service types are provided only as illustrative examples. 3GPP system may support optimizations in order to improve experience, improved capacity utilization in the RAN for deterministic services, extended reality/augmented reality (XR/AR) services, video services, IoT services (e.g., motion control, control-to-sensor/actuator communications, mobile robots and automated guided vehicles (AGVs), remote access and maintenance, closed-loop process control, plant asst management, and/or the like), etc. 3GPP supports QoS framework which is modelled based on fixed 5QI assignment (PDB, PER) for a given service. O-RAN introduced Real time RIC and non-Real time RIC in order to support artificial intelligence/machine learning (AI/ML) type analysis and provided optimization guidance to the RAN that can be considered for a given UE's session (QoS, mobility etc). FIG. 2 can illustrate an architecture for an implementation of an open RAN (O-RAN).

FIG. 2 is a block diagram illustrating a portion of a radio-access network (RAN) architecture according to an example embodiment. A RAN 200 architecture can include the ability to utilize machine learning (ML) systems and artificial intelligence back end modules to implement network intelligence in a multi-vendor network. The learning technologies can be used to generate and deploy ML models and policies to control the real time behaviour of the RAN 200 or by focusing on optimizing the RAN 200 using configurations, policies and triggers.

As shown in FIG. 2, the RAN 200 can include a service management and orchestration (SMO) framework 205. The SMO framework 205 can include a non-real time RAN intelligent controller (RIC) 210. The RAN can further include a near-real time RIC 215, a BS 220 (e.g., an eNB or a gNB), a central unit-control plane (CU-CP) 225, a central unit-user plane (CU-UP) 230, a distributed unit (DU) 235, a radio unit (RU) 240 and a cloudification and orchestration platform 245.

The SMO framework 205 can include the non-real time RIC 210 which can support intelligent RAN optimization in non-real-time (e.g., greater than one second) by providing policy-based guidance using data analytics and AI/IL training/inference. The non-real time RIC 210 can leverage SMO services such as data collection and provisioning services.

The near-real time RIC 215 can enable near real-time control and optimization of RAN (e.g., CU and DU) nodes and resources with near real-time control loops (e.g., 10 ms to 1 s). The near-real time RIC 215 can use monitor, suspend/stop, override and/or control primitives to control the behaviours of the RAN nodes. The near-real time RIC 215 can host applications (e.g., xApps) and collect near real-time RAN information to provide services, the control primitives, guided by policies and data provided from the non-real time RIC 210.

Network performance and network resources can be continually monitored with a real-time closed-loop control. The RAN 200 can be configured to offer efficient, optimized radio resource management through closed-loop control in order to enhance network performance and user experience. Interactions between the non-real time RIC 210 and the near-real time RIC 215 can be used to optimize and fine-tune control algorithms related to, for example, load balancing, mobility management, multi-connection control, QoS management, network energy saving, and the like.

The BS 220 (e.g., an eNB or a gNB) can be configured to provide wireless coverage to one or more UEs within a cell. The CU-CP 225 and the CU-UP 230 can be configured to provide control functions and/or data-plane functions for one or more connected DUs including, for example, control functions such as gNB control of transfer of user data, mobility control, radio access network sharing, positioning, session management, and the like, except those functions allocated exclusively to the DU.

The DU 235 can be configured to provide or establish wireless communications with one or more UEs. Thus, a DU may provide one or more cells, and may allow UEs to communicate with and/or establish a connection to the DU in order to receive wireless services, such as allowing the UE to send or receive data. The RU 240 (sometimes called a radio remote unit (RRU)) can be configured to transmit and receive signals over one or more frequencies. The RU 240 can include an air interface.

The cloudification and orchestration platform 245 can be configured to enable flexible deployment options and service provisioning models of RAN 200 virtualized network elements. The cloudification and orchestration platform 245 can be a cloud computing platform including a collection of physical infrastructure nodes that can host RAN functions, supporting software components, and management and orchestration functions.

Existing systems (e.g., RAN or O-RAN) do not provide a mechanism for a BS (e.g., gNB, eNB) and the RIC to correlate the knowledge of the traffic patterns available at the BS with the applications that are generating these traffic patterns: (1) the RIC is unable to correlate traffic statistics reported by the BS on a per UE, data radio bearer (DRB), and/or quality of service (QoS) (UE/DRB/QoS) flow basis for a given application, because the RIC is not aware of UE level identifiers (i.e., unique UE identifiers); (2) the BS is unable to correlate traffic optimization reported by the RIC on a per application basis for a given UE/DRB/QoS flow basis, because there is no parameter that can be used to determine or characterize a given application; (3) the only identifier that is available in the BS are 5G QoS identifiers (5QI).

However, differentiating applications/services based on 5QI is not possible because systems do not provide as many 5QI(s) as the number of applications supported. In addition, setting up new 5QIs is a cumbersome task requiring E2E reconfigurations and hence rarely a desirable solution for operators.

Another possible identifier is a QoS flow identifier (QFI), but this cannot be used to identify the application across QoS flows and UE(s) as QFI is designed to identify the QoS flow and the end user experience is determined by the performance of all the QoS flows associated with a given application.

Further, without knowing the traffic type and details like Time Sensitive Communication (TSC) Assistance Information (TSCAI), including, for example, burst arrival time (BAT), periodicity, burst size, burst spread, jitter, and/or the like, of deterministic traffic continuously, effective radio scheduling optimization is difficult because (1) deterministic flows require transmission within a specific time window (e.g., not too early and not too late); (2) an application server is assumed to provide TSCAI, though how all application servers (requiring TSC services) will be able to provide and guard BAT, periodicity, burst size, and/or the like is unclear; (3) TSCAI is passed over NG application protocol (NGAP) but not always and may, at times, be inaccurate/not precise (currently there is no option in RAN to identify TSCAI when not available or inaccurate); and (4) without knowing the traffic type and details like TSCAI of deterministic traffic, effective radio scheduling optimization can be difficult.

Broadening the deterministic time sensitive communication scenario can enable optimization of radio scheduling knowing the type of traffic, such as extended reality/augmented reality (XR/AR) (View port), Video, Gaming and its characteristics. However, existing systems do not provide a standard mechanism to deliver user plane/QoE related analytics information to the near-real time RIC. This information could be ascertained from deep packet inspection (DPI) engines, probes, analytics engines, applications which are typically computationally expensive and additional integration and maintenance efforts. The lack of availability of this information hinders provision of a service aware RAN.

In order to enable service-based RAN awareness, according to at least one example embodiment, the BS (e.g., gNB, eNB) and the RIC can enable use of a UE report from the BS to the RIC and assistance information from the RIC to the BS on a per application basis. The session management function (SMF) can provide a Correlation ID to identify the application for a given QoS flow. For time sensitive communication (TSC) protocol data unit (PDU) Sessions/QoS flows, the Correlation ID can indicate TSC. For XR flows, the Correlation ID can indicate XR For URLLC flows, the correlation ID can indicate URLLC (or more generically a corresponding Application ID).

According to at least one example embodiment, the BS (e.g., CU-CP) can monitor a traffic pattern both for uplink (UL) and downlink (DL) on a per DRB, UE level and report this to the RIC. The report can include the Correlation ID and/or Application ID. The RIC can collect the information provided by the BS(s) for an application over a period of time. With artificial intelligence (AI), the RIC can analyse the traffic pattern and define the TSCAI information (burst size, periodicity, burst spread, jitter, and/or the like) for a specific application in the RIC and periodically report this information to the BS (e.g., CU-UP). This information can be leveraged by the BS to optimize resource allocation (e.g., reserve transmission time interval (TTI)/slots, minimize overheads from overbooking factors, etc.) based on the monitored and reported traffic pattern. Example techniques can be extended to non-deterministic traffic with specific information (e.g., view port information) for a specific traffic type (e.g., XR traffic).

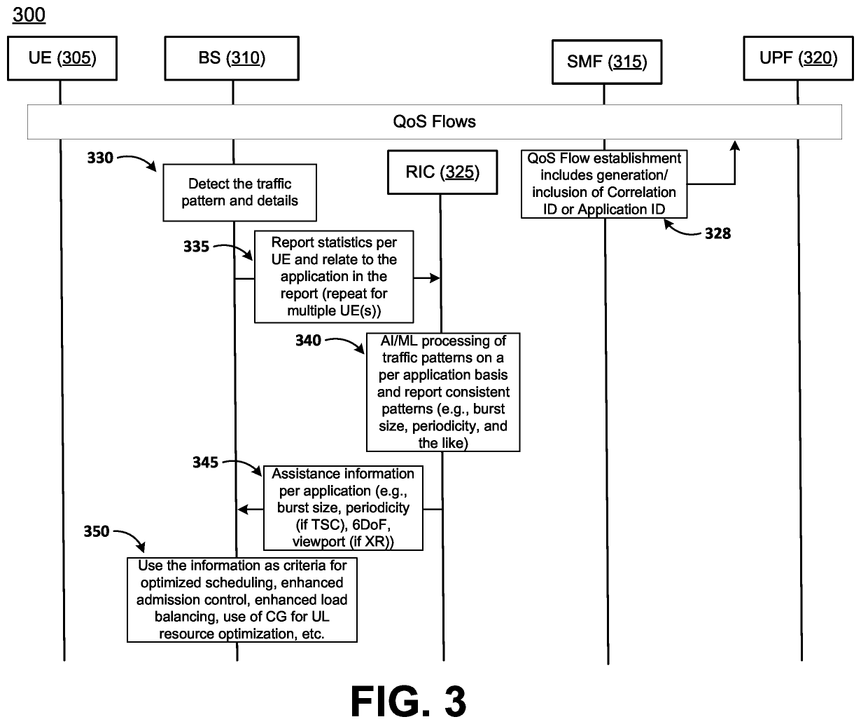

Advantages of the example embodiments can be to provide a solution for a 3GPP RAN and RIC to correlate the input from a BS (by the RIC) and output by the RIC (by BS) on a per application basis at the RIC. At the same time example embodiments can apply the solution on a per DRB/QoS flow basis for a given UE in the BS. To provide a solution for 3GPP RAN (along with the RIC) to determine traffic pattern(s) per application by analysing traffic pattern(s) for multiple UE(s) over a period of time. Optimizations provided by the RIC can be leveraged to enhance scheduling, enhance admission control, also improve capacity of the BS (e.g., traffic pattern determination enables the BS to accept a more guaranteed bit rate (GBR) DRBs for the UE(s)). FIG. 3 can be used to describe an example signal flow for enabling service-based RAN awareness based on the example embodiment(s).

FIG. 3 is a RAN signal flow diagram according to an example embodiment. As shown in FIG. 3, a signal flow 300 includes communications between a UE 305, a BS 310, a SMF 315 and a UPF 320. The signal flow 300 further includes communications between the BS 310 and a RIC 325. As shown in FIG. 3 a QoS flow exists between the UE 305, the BS 310, the SMF 315 and the UPF 320. Upon QoS Flow establishment (328), SMF 315 includes a Correlation ID or Application ID based on the traffic type and service the QoS Flow is created for. However, the RIC 325 does not have direct access to the QoS signal flow. Therefore, any QoS data that could help processing in the RIC 325 can be processed by the BS 310 and communicated to the RIC 325.

As shown in FIG. 3, the BS 330 can detect (330) traffic patterns and details. The traffic patterns and details can be associated with one or more UE and one or more application. The BS 310 can be and/or include a gNB, an eNB, a CU, a DU, an RU and the like. The BS 310 can monitor a traffic pattern both for UL and DL on a per DRB, UE level and generate a report. The report can include a Correlation ID and/or Application ID. The SMF 315 can provide (and the BS 310 can use) a correlation ID to identify the application for a given QoS flow (e.g., 5QI, per UE and/or application) during QoS Flow establishment or modification.

The BS 310 then communicates a message (335) to the RIC 325. The message can include a reporting of raw data and/or statistics (e.g., sample data traffic, traffic parameters, and/or the like) for at least one UE as related to the application associated with (e.g., included in) the report (repeat for multiple UE(s)). For example, an application can be associated with a plurality of UEs (e.g., served by RAN 200). The report can be for the application and include statistics associated with each of the plurality of UEs. The report can associate an application with the data and/or UE. For example, an Application ID and/or a Correlation ID can be used to associate an application with the data and/or UE. For time sensitive communication (TSC) protocol data unit (PDU) Sessions/QoS flows, the correlation ID can indicate TSC. For XR flows, the Correlation ID can indicate XR For URLLC flows, the Correlation ID can indicate URLLC (or more generically the corresponding Application ID and the like).

Alternatively, a report for each of the UEs can be communicated to the RIC 325. Each of the reports can include the Correlation ID and/or Application ID corresponding to the application associated with the report. In an example implementation, a plurality of applications can be served by the RAN (e.g., RAN 200). Each of the plurality of applications can be associated with a Correlation ID and/or Application ID. A plurality of reports based on the plurality of applications can be communicated from the BS 310 to the RIC 325.

The RIC 325 can perform AI/ML processing (340) of traffic patterns on a per application basis and report (e.g., generate a report) consistent patterns (e.g., burst size, periodicity, and the like). The RIC 325 can collect the information (report) communicated from the BS 310 for an application over a period of time. With AI, the RIC 325 can analyse the traffic pattern and define the TSCAI information (burst size, periodicity, burst spread, jitter, and/or the like) for a specific application in the RIC and to periodically report this information to the BS 310.

For example, a trained ML model can be used to analyse traffic patterns associated with an application. The trained ML model can be configured to generate assistance information (associated with an application or per application) based on the traffic patterns. The assistance information can include burst size, periodicity, six degrees of freedom (6DoF), viewport, and/or the like. The assistance information can be included in the generated report.

The RIC 325 then communicates a message (345) to the BS 310. The report can include assistance information. For example, the RIC can communicate burst size, periodicity (if TSC), 6DoF, viewport (if XR), and/or the like to the BS 310. The BS 310 can use the assistance information for facilitating service-based RAN awareness. The BS 310 can use the information (350) as criteria for optimized scheduling, enhanced admission control, enhanced load balancing, use of Configured Grants (CG) for UL resource optimization, and/or the like. In an example implementation, this information can be used by the BS 310 to optimize resource allocation (e.g., reserve transmission time interval (TTI)/slots, minimize overheads from overbooking factors, etc.) based on the monitored and reported traffic pattern. Example techniques can be extended to non-deterministic traffic with specific information (e.g., view port information) for a specific traffic type (e.g., XR traffic). FIG. 3 can describe the call flow to illustrate a BS to RIC procedure for gathering traffic pattern(s) and reporting analytics on a per application basis.

In an example implementation, a Correlation ID or an Application ID could be used to associate the UE report from the BS 310 to the RIC 325 and assistance information on a per application basis. Alternatively, the SMF 315 can provide the uplink and downlink filters used. The Correlation ID or the Application ID can enable the BS 310 and the RIC 325 to perform statistics on a per application basis using the type of application and/or identify the application using 5-tuples and application ID. The policy control function (PCF)/SMF can derive this based on a type of application and/or 5QI to be used.

Example implementations can enable the BS reporting traffic pattern(s) at per UE/DRBs/QoS flow level. Also, the RIC processing of the reports from BS for various UEs and consolidating the traffic pattern at an application level (even without any knowledge of a given UE/QoS Flow or DRB), reporting the optimization to the gNB on a per application level to improve scheduling and capacity. In addition, the gNB can apply the reported optimization at an application level for a given UE/DRB/QoS flow level for improved traffic scheduling for existing sessions and improved admission control for new UE(s)/DRB setup requests. The RIC provided assistance information can also be used for load balancing purposes.

A Radio Scheduler can determine parameters like periodicity, burst size, and the like based on traffic pattern arrival for a deterministic traffic. This information can be used by the radio scheduler to regulate traffic scheduling by tuning the scheduler within CU-UP in order to ensure on time delivery (which is the key requirement for time sensitive traffic), admission control, avoid overbooking thereby improving capacity utilization. Burst size, periodicity, burst spread, jitter for a given flow direction are beneficial in case of URLLC, TSC/deterministic application. TSCAI would be beneficial during admission control. Whereas in case of XR traffic like XR, viewport information can be beneficial during admission control.

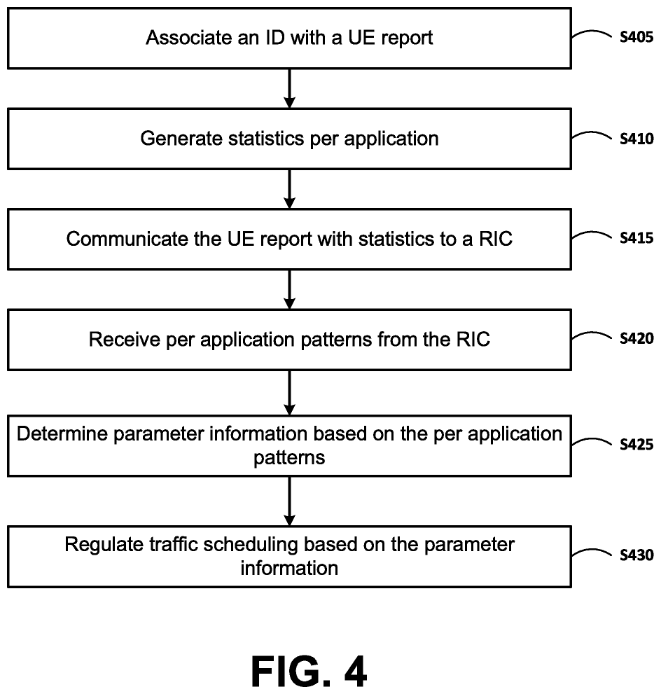

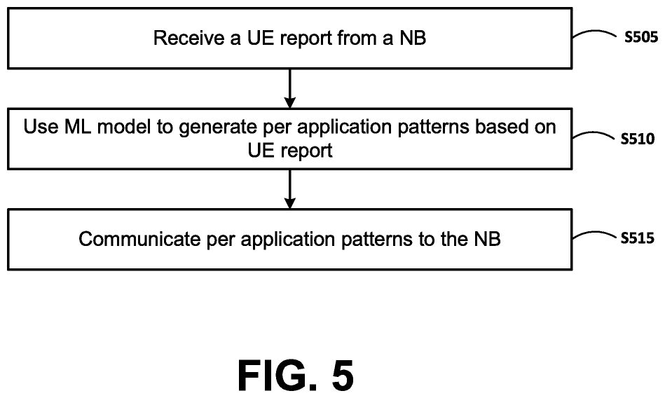

FIGS. 4 and 5 are flowcharts of methods according to example embodiments. The methods described with regard to FIGS. 4 and 5 may be performed due to the execution of software code stored in a memory (e.g., a non-transitory computer readable storage medium) associated with an apparatus (e.g., RAN 200) and executed by at least one processor associated with the apparatus. The software code can be configured to implement the techniques described herein. However, alternative embodiments are contemplated such as a system embodied as a special purpose processor. Although the methods described below are described as being executed by a processor and/or a special purpose processor, the methods are not necessarily executed by a same processor. In other words, at least one processor and/or at least one special purpose processor may execute the method described below with regard to FIGS. 4 and 5.

FIG. 4 is a block diagram of a method for optimizing traffic according to an example embodiment. As shown in FIG. 4, in step S405 an ID is associated with a UE report. For example, a Correlation ID obtained from the SMF can be assigned to the UE report. For example, an ID associated with an application (e.g., an Application ID) can be assigned to the UE report. In an example implementation, the Correlation ID and/or the Application ID can be provided by/received from the SMF (e.g., SMF 315). An application can be associated with a plurality of UEs. Therefore, each UE report associated with a specific application will have the same Application ID and/or Correlation ID.

In step S410 statistics per application are generated. For example, data associated with cells and UE's (e.g., 5QI, traffic patterns, load, and/or the like) can be collected by the BS. The BS can be a gNB, an eNB, a CU, a DU, an RU and the like. The data can be associated with key performance indicators (KPI). The KPI can be based on UE measurements, node measurements, node performance metrics, load (e.g., node load) measurements, and/or the like. The KPI can be based on CU and DU measurements or information. The KPI data can be data associated with (e.g., filtered to include) an application.

In step S415 the UE report with statistics is communicated to a RIC. For example, the statistics per application or KPI per application can be communicated to the RIC. The RIC can determine (e.g., using at least one ML model) patterns (e.g., traffic patterns) associated with the application. The traffic patterns associated with the application can be based on the application as associated with a plurality of UEs. In an example implementation, the BS (e.g., gNB) can report raw traffic characteristics (e.g., as observed by the BS) to the RIC on a per UE/DRB basis associated to a correlation ID/application ID. For example, the BS (e.g., BS 310) can report UE-1/DRB1 characteristic and associate the characteristics with the Correlation ID/Application ID to the RIC (e.g., RIC 325). The BS (e.g., BS 310) can report UE-2/DRB2 characteristics and associate the characteristics with the Correlation ID/Application ID to the RIC (e.g., RIC 325). The BS (e.g., BS 310) can report UE-3/DRB1 characteristics and associate the characteristics with the Correlation ID/Application ID to the RIC (e.g., RIC 325). According to at least one example embodiment, the BS can monitor a traffic pattern both for UL and DL on a per DRB, UE level and report this to the RIC. The report can include the Correlation ID and/or Application ID. The RIC can collect the information provided by the BS(s) for an application over a period of time.

In step S420 per application patterns are received from the RIC. For example, the patterns can be generated by the RIC for intelligent radio resource management, higher layer procedure optimization, policy optimization in RAN, and/or the like. The patterns can include network spatial-temporal traffic patterns, user mobility patterns, service type/patterns along with the corresponding prediction models, network quality of service (QoS) prediction patterns, massive MIMO parameters configuration and other patterns that can optimize network radio resource management. The traffic patterns can be (or be associated with) deterministic traffic (e.g., same/similar periodicity, same burst size, and/or the like). The per application patterns can be generated by the near-real time RIC (e.g., RIC 215) and/or the non-real time RIC (e.g., RIC 210).

In step S425 parameter information is determined based on the per application patterns. For example, parameters can include parameters such as output power, EIRP, bandwidth, MIMO layer, automatic power consumption reduction, UE scheduling, and/or the like. The parameter information (e.g., values associated with the parameters) can be set based on the application and the UE. Therefore, an application executing in association with a plurality of UEs can influence RAN settings associated with the UE.

In step S430 traffic scheduling is regulated based on the parameter information. For example, traffic scheduling associated with the plurality of UEs associated with the application can be based on parameter information that was generated based on the applications operating characteristics (e.g., historical application statistics or application statistics collected over time). The parameter information can be leveraged by the BS to optimize resource allocation (e.g., reserve transmission time interval (TTI)/slots, minimize overheads from overbooking factors, etc.) based on the monitored and reported traffic pattern. Example techniques can be extended to non-deterministic traffic with specific information (e.g., view port information) for a specific traffic type (e.g., XR traffic). Continuing the example above, the BS (e.g., BS 310) can apply the assistance for all UE(s)/DRBs that are associated with the (e.g., the same) correlation ID/application ID (e.g., for UE-1/DRB1, UE-2, DRB2, UE-3/DRB-1).

FIG. 5 is a block diagram of a method for generating per application traffic patterns according to an example embodiment. As shown in FIG. 5, in step S505 a UE report is received from a BS. For example, the UE report can include statistics per application or KPI per application. The KPI can be based on UE measurements, node measurements, node performance metrics, load (e.g., node load) measurements, and/or the like. The KPI can be based on CU and DU measurements or information. The KPI data can be data associated with (e.g., filtered to include) an application.

In step S510 a ML model is used to generate per application patterns based on UE report. The RIC can collect the information provided by the BS(s) for an application over a period of time. With artificial intelligence (AI), the RIC can analyse the traffic pattern and define the TSCAI information (burst size, periodicity, burst spread, jitter, and/or the like) for a specific application in the RIC and periodically report this information to the BS (e.g., CU-UP). For example, the RIC can determine (e.g., using at least one ML model) patterns (e.g., traffic patterns) associated with the application. The traffic patterns associated with the application can be based on the application as associated with a plurality of UEs. The patterns can be generated by the RIC for intelligent radio resource management, higher layer procedure optimization, policy optimization in RAN, and/or the like. The patterns can include network spatial-temporal traffic patterns, user mobility patterns, service type/patterns along with the corresponding prediction models, network quality of service (QoS) prediction patterns, massive MIMO parameters configuration and other patterns that can optimize network radio resource management. The ML model can be associated with an application, a configuration, network requirements, system requirements, and/or the like. The ML model can be implemented by the near-real time RIC. The ML model can be trained by the non-real time RIC.

In step S515 the per application patterns are communicated to the BS. For example, the AI/ML generated per application patterns can be communicated from RIC 325 to BS 310. In an example implementation, the RIC (e.g., RIC 325) can collect all the reports received per correlation ID/application ID, determine the pattern to derive useful assistance information (e.g., TSCAI, periodicity, burst size for a given application) that can be provided to the BS (e.g., BS 310) and can associate the assistance information per correlation ID/application ID.

### Some Example Advantages

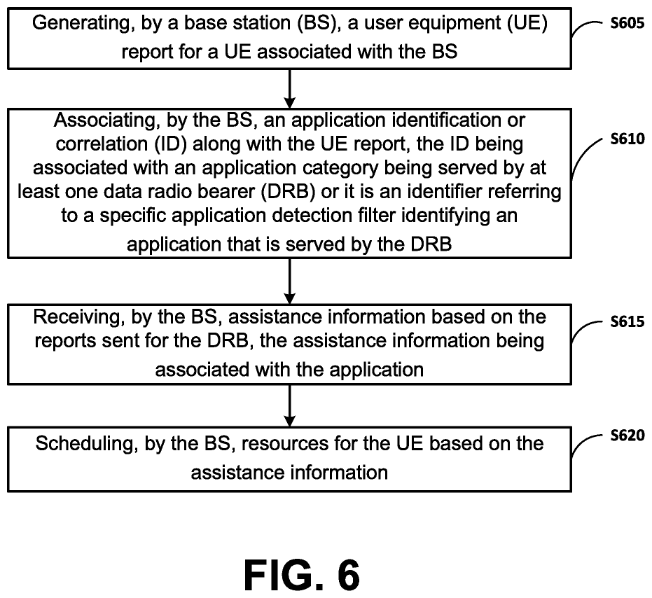

Example 1. FIG. 6 is a flowchart illustrating operation of a network device. Operation S605 includes generating, by a base station (BS), a user equipment (UE) report for a UE associated with the BS. Operation S610 includes associating, by the BS, an application identification or correlation (ID) along with the UE report, the ID being associated with an application category being served by at least one data radio bearer (DRB) or it is an identifier referring to a specific application detection filter identifying an application that is served by the DRB. Operation S615 includes receiving, by the BS, assistance information based on the reports sent for the DRB, the assistance information being associated with the application. Operation S620 includes scheduling, by the BS, resources for the UE based on the assistance information.

Example 2. The method of Example 1, further including monitoring, by the BS, a traffic pattern for an uplink (UL) on the DRB associated with the UE, monitoring, by the BS, a traffic pattern for a downlink (DL) on the DRB associated with the UE, wherein the UE report is based on data associated with the application acquired during the monitoring of the UL and the monitoring of the DL.

Example 3. The method of Example 1 or Example 2, wherein the assistance information includes Time Sensitive Communication Assistance Information (TSCAI).

Example 4. The method of any of Example 1 to Example 3, wherein the ID is a Correlation ID received by the BS from a session management function (SMF).

Example 5. The method of any of Example 1 to Example 4, wherein the ID is a correlation ID associated with an application category being served over one or more DRBs.

Example 6. The method of Example 4 or Example 5, wherein the Correlation ID is derived by the SMF based on the Traffic Flow Templates employed to map the service flows to the radio bearers.

Example 7. The method of any of Example 1 to Example 6, wherein the UE report is based on data associated with the application and a plurality of UEs employing the application.

Example 8. The method of any of Example 1 to Example 7, wherein the UE report is based on data associated with the UE implementing a plurality of applications and each of the plurality of applications is associated with a unique ID.

Example 9. The method of any of Example 1 to Example 8, wherein the assistance information is based on a statistical or machine learning (ML) model processing a plurality of UE reports.

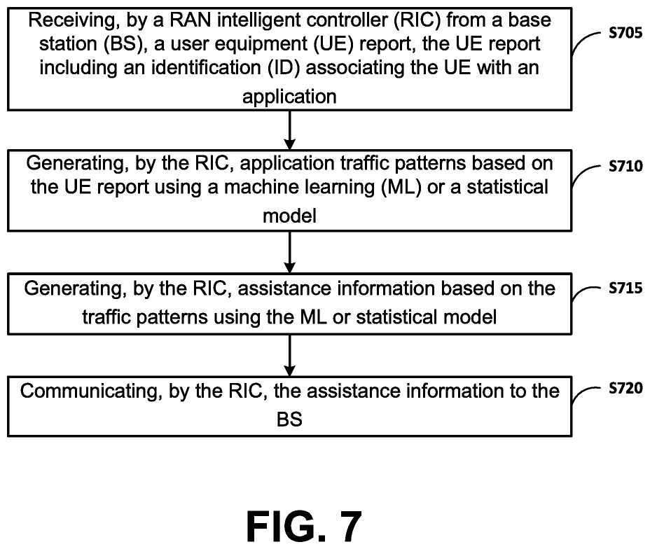

Example 10. FIG. 7 is a flowchart illustrating operation of a network device. Operation S705 includes receiving, by a RAN intelligent controller (RIC) from a base station (BS), a user equipment (UE) report, the UE report including an identification (ID) associating the UE with an application. Operation S710 includes generating, by the RIC, application traffic patterns based on the UE report using a machine learning (ML) or a statistical model. Operation S715 includes generating, by the RIC, assistance information based on the traffic patterns using the ML or statistical model. Operation S720 includes communicating, by the RIC, the assistance information to the BS.

Example 11. The method of Example 10, wherein the UE report is based on data associated with the application acquired during a monitoring of an uplink (UL) on a data radio bearer (DRB) associated with the UE and the monitoring of a downlink (DL) on the DRB associated with the UE.

Example 12. The method of Example 10 or Example 11, wherein the ID is a Correlation ID received by the BS from a session management function (SMF).

Example 13. The method of any of Example 10 to Example 12, wherein the ID is a correlation ID associated with an application category being served over one or more DRB.

Example 14. The method of any of Example 12 to Example 13, wherein the Correlation ID is derived by the SMF based on the Traffic Flow Templates employed to map the service flows to the radio bearers.

Example 15. The method of any of Example 10 to Example 14, wherein the application traffic is based on one application employed by a plurality of UEs.

Example 16. The method of any of Example 10 to Example 15, wherein the RIC includes a near-real time RIC and a non-real time RIC and the ML model is trained by the non-real time RIC.

Example 17. The method of any of Example 10 to Example 16, wherein the assistance information includes Time Sensitive Communication Assistance Information (TSCAI).

Example 18. The method of any of Example 10 to Example 17, wherein the RIC collects information from a plurality of UE reports associated with the application over a period of time, and the assistance information is based on the information collected over a period of time.

Example 19. A non-transitory computer-readable storage medium comprising instructions stored thereon that, when executed by at least one processor, are configured to cause a computing system to perform the method of any of Examples 1-18.

Example 20. An apparatus comprising means for performing the method of any of Examples 1-18.

Example 21. An apparatus comprising: at least one processor; and at least one memory including computer program code; the at least one memory and the computer program code configured to, with the at least one processor, cause the apparatus at least to perform the method of any of Examples 1-18.

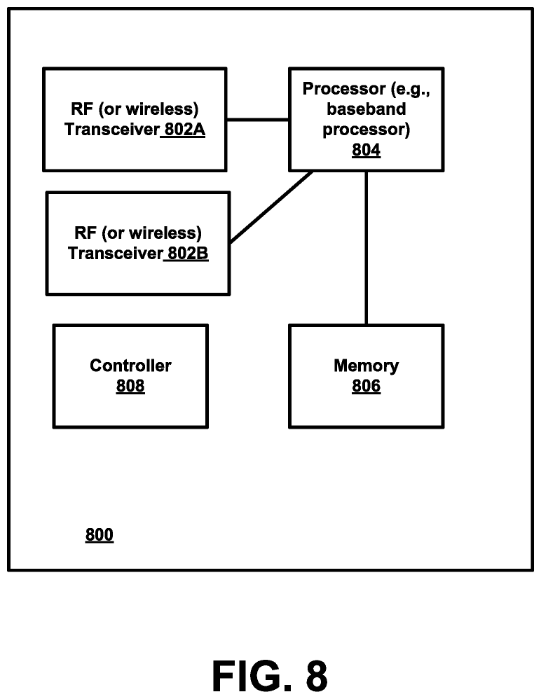

FIG. 8 is a block diagram of a wireless station 800 or wireless node or network node 800 according to an example embodiment. The wireless node or wireless station or network node 800 may include, e.g., one or more of an AP, BS, gNB, RAN node, relay node, UE or user device, network node, network entity, DU, CU-CP, CU-UP, . . . or other node) according to an example embodiment.

The wireless station 800 may include, for example, one or more (e.g., two as shown in FIG. 8) radio frequency (RF) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions.

Processor 804 may also make decisions or determinations, generate frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example embodiment, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
generating, by a base station (BS), a user equipment (UE) report for a UE associated with the BS;
associating, by the BS, an application identification or correlation (ID) along with the UE report, the ID being associated with an application category being served by at least one data radio bearer (DRB) or it is an identifier referring to a specific application detection filter identifying an application that is served by the DRB;
receiving, by the BS, assistance information based on the reports sent for the DRB, the assistance information being associated with the application; and
scheduling, by the BS, resources for the UE based on the assistance information.

2. The method of claim 1, further comprising:
monitoring, by the BS, a traffic pattern for an uplink (UL) on the DRB associated with the UE; and
monitoring, by the BS, a traffic pattern for a downlink (DL) on the DRB associated with the UE, wherein the UE report is based on data associated with the application acquired during the monitoring of the UL and the monitoring of the DL.

3. The method of claim 1 or claim 2, wherein the assistance information includes Time Sensitive Communication Assistance Information (TSCAI).

4. The method of any of claim 1 to claim 3, wherein the ID is a Correlation ID received by the BS from a session management function (SMF).

5. The method of any of claim 1 to claim 4, wherein the ID is a correlation ID associated with an application category being served over one or more DRBs.

6. The method of claim 4 or claim 5, wherein the Correlation ID is derived by the SMF based on the Traffic Flow Templates employed to map the service flows to the radio bearers.

7. The method of any of claim 1 to claim 6, wherein the UE report is based on data associated with the application and a plurality of UEs employing the application.

8. The method of any of claim 1 to claim 7, wherein the UE report is based on data associated with the UE implementing a plurality of applications and each of the plurality of applications is associated with a unique ID.

9. The method of any of claim 1 to claim 8, wherein the assistance information is based on a statistical or machine learning (ML) model processing a plurality of UE reports.

10. A non-transitory computer-readable storage medium comprising instructions stored thereon that, when executed by at least one processor, are configured to cause a computing system to perform steps comprising:
generating, by a base station (BS), a user equipment (UE) report for a UE associated with the BS;
associating, by the BS, an application identification or correlation (ID) along with the UE report, the ID being associated with an application category being served by at least one data radio bearer (DRB) or it is an identifier referring to a specific application detection filter identifying an application that is served by the DRB;
receiving, by the BS, assistance information based on the reports sent for the DRB, the assistance information being associated with the application; and
scheduling, by the BS, resources for the UE based on the assistance information.

11. The non-transitory computer-readable storage medium of claim 10, the step further comprising:
monitoring, by the BS, a traffic pattern for an uplink (UL) on the DRB associated with the UE; and
monitoring, by the BS, a traffic pattern for a downlink (DL) on the DRB associated with the UE, wherein the UE report is based on data associated with the application acquired during the monitoring of the UL and the monitoring of the DL.

12. The non-transitory computer-readable storage medium of claim 10 or claim 11, wherein the assistance information includes Time Sensitive Communication Assistance Information (TSCAI).

13. The non-transitory computer-readable storage medium of any of claim 10 to claim 12, wherein the ID is a Correlation ID received by the BS from a session management function (SMF).

14. The non-transitory computer-readable storage medium of any of claim 10 to claim 13, wherein the ID is a correlation ID associated with an application category being served over one or more DRBs.

15. The non-transitory computer-readable storage medium of claim 13 or claim 14, wherein the Correlation ID is derived by the SMF based on the Traffic Flow Templates employed to map the service flows to the radio bearers.

16. The non-transitory computer-readable storage medium of any of claim 10 to claim 15, wherein the UE report is based on data associated with the application and a plurality of UEs employing the application.

17. The non-transitory computer-readable storage medium of any of claim 10 to claim 16, wherein the UE report is based on data associated with the UE implementing a plurality of applications and each of the plurality of applications is associated with a unique ID.

18. The non-transitory computer-readable storage medium of any of claim 10 to claim 17, wherein the assistance information is based on a statistical or machine learning (ML) model processing a plurality of UE reports.

19. An apparatus comprising:
means for generating, by a base station (BS), a user equipment (UE) report for a UE associated with the BS;
means for associating, by the BS, an application identification or correlation (ID) along with the UE report, the ID being associated with an application category being served by at least one data radio bearer (DRB) or it is an identifier referring to a specific application detection filter identifying an application that is served by the DRB;
means for receiving, by the BS, assistance information based on the reports sent for the DRB, the assistance information being associated with the application; and
means for scheduling, by the BS, resources for the UE based on the assistance information.

20. The apparatus of claim 19, further comprising:
means for monitoring, by the BS, a traffic pattern for an uplink (UL) on the DRB associated with the UE; and
means for monitoring, by the BS, a traffic pattern for a downlink (DL) on the DRB associated with the UE, wherein the UE report is based on data associated with the application acquired during the monitoring of the UL and the monitoring of the DL.

21. The apparatus of claim 19 or claim 20, wherein the assistance information includes Time Sensitive Communication Assistance Information (TSCAI).

22. The apparatus of any of claim 19 to claim 21, wherein the ID is a Correlation ID received by the BS from a session management function (SMF).

23. The apparatus of any of claim 19 to claim 22, wherein the ID is a correlation ID associated with an application category being served over one or more DRBs.

24. The apparatus of claim 22 or claim 23, wherein the Correlation ID is derived by the SMF based on the Traffic Flow Templates employed to map the service flows to the radio bearers.

25. The apparatus of any of claim 19 to claim 24, wherein the UE report is based on data associated with the application and a plurality of UEs employing the application.

26. The apparatus of any of claim 19 to claim 25, wherein the UE report is based on data associated with the UE implementing a plurality of applications and each of the plurality of applications is associated with a unique ID.

27. The apparatus of any of claim 19 to claim 26, wherein the assistance information is based on a statistical or machine learning (ML) model processing a plurality of UE reports.

28. An apparatus comprising:
at least one processor; and
at least one memory including computer program code;
the at least one memory and the computer program code configured to, with the at least one processor, cause the apparatus at least to perform steps comprising:
generating, by a base station (BS), a user equipment (UE) report for a UE associated with the BS;
associating, by the BS, an application identification or correlation (ID) along with the UE report, the ID being associated with an application category being served by at least one data radio bearer (DRB) or it is an identifier referring to a specific application detection filter identifying an application that is served by the DRB;
receiving, by the BS, assistance information based on the reports sent for the DRB, the assistance information being associated with the application; and
scheduling, by the BS, resources for the UE based on the assistance information.

29. The apparatus of claim 28, further comprising:
monitoring, by the BS, a traffic pattern for an uplink (UL) on the DRB associated with the UE; and
monitoring, by the BS, a traffic pattern for a downlink (DL) on the DRB associated with the UE, wherein the UE report is based on data associated with the application acquired during the monitoring of the UL and the monitoring of the DL.

30. The apparatus of claim 28 or claim 29, wherein the assistance information includes Time Sensitive Communication Assistance Information (TSCAI).

31. The apparatus of any of claim 28 to claim 30, wherein the ID is a Correlation ID received by the BS from a session management function (SMF).

32. The apparatus of any of claim 28 to claim 31, wherein the ID is a correlation ID associated with an application category being served over one or more DRBs.

33. The apparatus of claim 31 or claim 32, wherein the Correlation ID is derived by the SMF based on the Traffic Flow Templates employed to map the service flows to the radio bearers.

34. The apparatus of any of claim 28 to claim 33, wherein the UE report is based on data associated with the application and a plurality of UEs employing the application.

35. The apparatus of any of claim 28 to claim 34, wherein the UE report is based on data associated with the UE implementing a plurality of applications and each of the plurality of applications is associated with a unique ID.

36. The apparatus of any of claim 28 to claim 35, wherein the assistance information is based on a statistical or machine learning (ML) model processing a plurality of UE reports.

37. A method comprising:
receiving, by a RAN intelligent controller (RIC) from a base station (BS), a user equipment (UE) report, the UE report including an identification (ID) associating the UE with an application;
generating, by the RIC, application traffic patterns based on the UE report using a machine learning (ML) or a statistical model;
generating, by the RIC, assistance information based on the traffic patterns using the ML or statistical model; and
communicating, by the RIC, the assistance information to the BS.

38. The method of claim 37, wherein the UE report is based on data associated with the application acquired during a monitoring of an uplink (UL) on a data radio bearer (DRB) associated with the UE and the monitoring of a downlink (DL) on the DRB associated with the UE.

39. The method of claim 37 or claim 38, wherein the ID is a Correlation ID received by the BS from a session management function (SMF).

40. The method of any of claim 37 to claim 39, wherein the ID is a correlation ID associated with an application category being served over one or more DRB.

41. The method of any of claim 39 to claim 40, wherein the Correlation ID is derived by the SMF based on the Traffic Flow Templates employed to map the service flows to the radio bearers.

42. The method of any of claim 37 to claim 41, wherein the application traffic is based on one application employed by a plurality of UEs.

43. The method of any of claim 37 to claim 42, wherein the RIC includes a near-real time RIC and a non-real time RIC and the ML model is trained by the non-real time RIC.

44. The method of any of claim 37 to claim 43, wherein the assistance information includes Time Sensitive Communication Assistance Information (TSCAI).

45. The method of any of claim 37 to claim 44, wherein
the RIC collects information from a plurality of UE reports associated with the application over a period of time, and
the assistance information is based on the information collected over a period of time.

46. A non-transitory computer-readable storage medium comprising instructions stored thereon that, when executed by at least one processor, are configured to cause a computing system to perform steps comprising:
receiving, by a RAN intelligent controller (RIC) from a base station (BS), a user equipment (UE) report, the UE report including an identification (ID) associating the UE with an application;
generating, by the RIC, application traffic patterns based on the UE report using a machine learning (ML) or a statistical model;
generating, by the RIC, assistance information based on the traffic patterns using the ML or statistical model; and
communicating, by the RIC, the assistance information to the BS.

47. The non-transitory computer-readable storage medium of claim 46, wherein the UE report is based on data associated with the application acquired during a monitoring of an uplink (UL) on a data radio bearer (DRB) associated with the UE and the monitoring of a downlink (DL) on the DRB associated with the UE.

48. The non-transitory computer-readable storage medium of claim 46 or claim 47, wherein the ID is a Correlation ID received by the BS from a session management function (SMF).

49. The non-transitory computer-readable storage medium of any of claim 46 to claim 48, wherein the ID is a correlation ID associated with an application category being served over one or more DRB.

50. The non-transitory computer-readable storage medium of any of claim 48 to claim 49, wherein the Correlation ID is derived by the SMF based on the Traffic Flow Templates employed to map the service flows to the radio bearers.

51. The non-transitory computer-readable storage medium of any of claim 46 to claim 50, wherein the application traffic is based on one application employed by a plurality of UEs.

52. The non-transitory computer-readable storage medium of any of claim 46 to claim 51, wherein the RIC includes a near-real time RIC and a non-real time RIC and the ML model is trained by the non-real time RIC.

53. The non-transitory computer-readable storage medium of any of claim 46 to claim 52, wherein the assistance information includes Time Sensitive Communication Assistance Information (TSCAI).

54. The non-transitory computer-readable storage medium of any of claim 46 to claim 53, wherein
the RIC collects information from a plurality of UE reports associated with the application over a period of time, and
the assistance information is based on the information collected over a period of time.

55. An apparatus comprising:
means for receiving, by a RAN intelligent controller (RIC) from a base station (BS), a user equipment (UE) report, the UE report including an identification (ID) associating the UE with an application;
means for generating, by the RIC, application traffic patterns based on the UE report using a machine learning (ML) or a statistical model;
means for generating, by the RIC, assistance information based on the traffic patterns using the ML or statistical model; and
means for communicating, by the RIC, the assistance information to the BS.

56. The apparatus of claim 55, wherein the UE report is based on data associated with the application acquired during a monitoring of an uplink (UL) on a data radio bearer (DRB) associated with the UE and the monitoring of a downlink (DL) on the DRB associated with the UE.

57. The apparatus of claim 55 or claim 56, wherein the ID is a Correlation ID received by the BS from a session management function (SMF).

58. The apparatus of any of claim 55 to claim 57, wherein the ID is a correlation ID associated with an application category being served over one or more DRB.

59. The apparatus of any of claim 57 to claim 58, wherein the Correlation ID is derived by the SMF based on the Traffic Flow Templates employed to map the service flows to the radio bearers.

60. The apparatus of any of claim 55 to claim 59, wherein the application traffic is based on one application employed by a plurality of UEs.

61. The apparatus of any of claim 55 to claim 60, wherein the RIC includes a near-real time RIC and a non-real time RIC and the ML model is trained by the non-real time RIC.

62. The apparatus of any of claim 55 to claim 61, wherein the assistance information includes Time Sensitive Communication Assistance Information (TSCAI).

63. The apparatus of any of claim 55 to claim 62, wherein
the RIC collects information from a plurality of UE reports associated with the application over a period of time, and
the assistance information is based on the information collected over a period of time.

64. An apparatus comprising:
at least one processor; and
at least one memory including computer program code;
the at least one memory and the computer program code configured to, with the at least one processor, cause the apparatus at least to perform steps comprising:
receiving, by a RAN intelligent controller (RIC) from a base station (BS), a user equipment (UE) report, the UE report including an identification (ID) associating the UE with an application;
generating, by the RIC, application traffic patterns based on the UE report using a machine learning (ML) or a statistical model;
generating, by the RIC, assistance information based on the traffic patterns using the ML or statistical model; and
communicating, by the RIC, the assistance information to the BS.

65. The apparatus of claim 64, wherein the UE report is based on data associated with the application acquired during a monitoring of an uplink (UL) on a data radio bearer (DRB) associated with the UE and the monitoring of a downlink (DL) on the DRB associated with the UE.

66. The apparatus of claim 64 or claim 65, wherein the ID is a Correlation ID received by the BS from a session management function (SMF).

67. The apparatus of any of claim 64 to claim 66, wherein the ID is a correlation ID associated with an application category being served over one or more DRB.

68. The apparatus of any of claim 66 to claim 67, wherein the Correlation ID is derived by the SMF based on the Traffic Flow Templates employed to map the service flows to the radio bearers.

69. The apparatus of any of claim 64 to claim 68, wherein the application traffic is based on one application employed by a plurality of UEs.

70. The apparatus of any of claim 64 to claim 69, wherein the RIC includes a near-real time RIC and a non-real time RIC and the ML model is trained by the non-real time RIC.

71. The apparatus of any of claim 64 to claim 70, wherein the assistance information includes Time Sensitive Communication Assistance Information (TSCAI).

72. The apparatus of any of claim 64 to claim 71, wherein
the RIC collects information from a plurality of UE reports associated with the application over a period of time, and
the assistance information is based on the information collected over a period of time.
